(19) United States
(12) Patent Application Publication
(10) Pub. No.: US 2017/0328129 A1
(43) Pub. Date: Nov. 16, 2017

(54) SCREEN DEVICE

(71) Applicant: RENSON SUNPROTECTION-SCREENS NV, Waregem (BE)

(72) Inventors: Jonas Willem MAERTENS, Gent (BE); Joost Benjamin Renaat DE FRENE, Waregem (BE)

(73) Assignee: RENSON SUNPROTECTION-SCREENS NV, Waregem (BE)

(21) Appl. No.: 15/529,929

(22) PCT Filed: Nov. 25, 2015
(86) PCT No.: PCT/IB2015/059119

§ 371 Date: May 25, 2017

(30) Foreign Application Priority Data
Nov. 25, 2014 (BE) 2014/5085
Jul. 10, 2015 (BE) 2015/5438

(51) Int. Cl. E06B 9/42; E06B 9/13; E06B 9/17; E06B 9/58

(52) U.S. Cl. CPC E06B 9/42; E06B 9/58; E06B 9/13; E06B 9/17

(57) ABSTRACT

A screen device (1) comprising two fabric rollers (23 24), which, in the mounted state of the screen device (1), are arranged at an angle (a) relative to each other, and comprising, for each fabric roller (23, 24):—a screen (2, 3) which can be rolled up and unrolled on the fabric roller (23, 24);—a bottom lath (4, 5), which in the mounted state of the screen device, is fastened to the screen (2, 3) on the side of the screen (2, 3) away from the fabric roller (23, 24);—and one or more screen and/or lath guides (6, 7), for guiding a lateral side of the screen (2, 3) and/or the bottom lath (4, 5); wherein, in the mounted state of the screen device (1), the bottom laths (4, 5) are rigidly connected to each other at the said angle (α).

This invention relates to a screen device comprising two fabric rollers, each rotatable about a respective fabric roller axis, wherein the fabric roller axes of these fabric rollers, in the mounted state of the screen device, are arranged at an angle relative to each other, and wherein the screen device, for each fabric roller:
comprises a screen, which can be rolled up and unrolled on the fabric roller;
comprises a bottom lath, which, in the mounted state of the screen device, is fastened to the screen on the side of the screen away from the fabric roller;
and comprises one or more screen and/or lath guides, for guiding a lateral side of the screen and/or the bottom lath.

The one or more screen and/or lath guides in screen devices of this type are provided to ensure that the screen will not excessively move, flap or get damaged under the influence of external factors, such as, for example, wind, etc.

In order to adequately guide the screens and/or the bottom laths, the screen and/or lath guides are disposed on both lateral sides of the screens. The screen and/or lath guides, which to this end are positioned on the angle of such a screen device, are often perceived as disturbing, however. Increasingly often, glass sections which stand arranged at an angle relative to each other are constructed up to this angle in glass, so that the view through these glass sections is not obstructed by a corner column or an angle profile. However, if a screen device has to be arranged for such a glass section, then a guide is still arranged for this angle, so that the view through these glass sections is still obstructed by a profile.

The object of this invention is to provide a solution to this problem.

This object of this invention is achieved by providing a screen device comprising two fabric rollers, each rotatable about a respective fabric roller axis, wherein the fabric roller axes of these fabric rollers, in the mounted state of the screen device, are arranged at an angle relative to each other, and wherein the screen device, for each fabric roller:
comprises a screen, which can be rolled up and unrolled on the fabric roller;
comprises a bottom lath, which, in the mounted state of the screen device, is fastened to the screen on the side of the screen away from the fabric roller;
and comprises one or more screen and/or lath guides, for guiding a lateral side of the screen and/or the bottom lath;
   wherein, in the mounted state of the screen device, the bottom laths are mutually connected at the said angle.

By connecting the bottom laths one to the other, screen and/or lath guides on the angle can be minimized or even omitted. By virtue of this connection and the fact that, at the other ends of the bottom laths, these bottom laths and/or the screens are still being guided, with minimization or omission of screen and/or lath guides on the angle sufficient guidance is still nevertheless provided to prevent the screen from excessively moving or flapping, etc.

Minimized screen and/or lath guides are perceived as less disturbing than the usual screen and/or lath guides.

Preferentially, the guides of a screen device according to this invention are arranged only on the lateral side of the respective screen and/or the respective bottom lath, away from the said angle, so that the screen and/or lath guides on the angle can be totally omitted.

In a specific embodiment of a screen device according to this invention, wherein a minimized screen guide and/or lath guide is provided on the angle, for the guidance of the corresponding lateral side of each screen a guide profile is fixedly arranged on the angle as a screen guide, and, on the lateral side of each respective screen and/or each respective bottom lath, away from the said angle, a guide profile for guiding this corresponding lateral side of the screen is resiliently mounted in an outer profile of the screen guide, for the laterally resilient tensioning of the screen. In this way, guide profiles resiliently mounted on this angle can now be replaced by fixedly arranged guide profiles which are perceived as less disturbing.

In order to resiliently mount the resiliently mounted guide profiles in a specific screen device of this type, these can more specifically, in the mounted state, be accommodated in a cavity of an outer profile of the screen guide and/or lath guide, wherein one or more spring elements are fitted in this cavity between this guide profile and this outer profile, or form part of the guide profile or the outer profile, for the laterally resilient tensioning of the screen.

The guide profiles in a specific screen device of this type for guiding the lateral sides of the screens on the angle preferably form part of a same screen guide in order to minimize the guide profiles on this angle.

Alternatively, it is also possible, for example, to simply construct a screen guide and/or lath guide of this type as a (limited) lath guide in order to minimize this same.

If a screen device according to this invention is provided with screen and/or lath guides on the angle, then the bottom laths are preferably provided on the angle with a recess, for fitting of the corresponding screen guide and/or lath guide guidingly herein.

A screen guide and/or lath guide, arranged on the angle, of a specific screen device according to this invention preferably comprises click means for clicking this screen guide and/or lath guide in place on a fastening profile of the screen device. This fastening profile then, in turn, preferably comprises click means, which can be clicked in place on the click means of the said screen guide and/or lath guide.

In the mounted state of a screen device according to this invention, the ends of the bottom laths, away from the said angle, are preferably guidingly fitted in the screen and/or lath guides.

Preferentially, the mutual connection of the bottom laths is of rigid construction.

In a preferential embodiment, the lateral sides of the screens and/or of the bottom laths, which are intended to be guided, are provided with one or more hook elements to hook into the screen and/or lath guides for guidance of these lateral sides in these screen and/or lath guides. In this way, these screens and/or bottom laths are prevented from detaching from the screen and/or lath guides under the action of certain forces. By virtue of the hook elements, the screens and/or bottom laths can remain hooked in the screen and/or lath guides.

Yet more preferentially, the screen and/or lath guides are of multipart construction, having an outer profile, which is fixedly arranged, and a guide profile for guiding the screen and/or the bottom lath, which is arranged spring-cushioned in this outer profile. The hook elements then hook in this case into the guide profile. This guide profile is hereupon preferably pretensioned transversely to its longitudinal direction, such that the screen, in the event of possible overloading by, for example, a person knocking against the screen, or under a wind load, can deflect somewhat, without damage to the screen or the screen device.

The screens, on their lateral side which is intended to be guided, are preferably provided with a flexible thickening as the said hook element. A flexible thickening of this type can in particular be realized, for example, as a half zip fastener.

In a specific embodiment of a screen device of this type having a flexible thickening on the screens as the said hook element, in the mounted state of the screen device the ends of the screens are clamped in the respective bottom laths, such that the flexible thickenings at these ends extend laterally relative to the respective bottom laths in order to form the said hook elements for the bottom laths.

In a particularly preferential embodiment of a screen device according to this invention, the bottom laths are of hollow construction; they comprise an access opening to their cavity on the side of the said angle, and the screen device comprises an angle fastening element, comprising two legs which are arranged at the said angle relative to each other and are each fittable into the cavity of a respective bottom lathe via the respective access opening, for the mutual connection of these bottom laths at the said angle.

With an angle fastening element of this type, which is fittable into cavities of the bottom laths, a simple firm connection of the bottom laths is possible.

Since the legs of this angle fastening element are arranged at the desired angle, the desired angle between the bottom laths is easily realizable.

A number of existing profiles for bottom laths in this case remain usable as the bottom lath.

These bottom laths are preferably substantially constructed from one or more extruded profiles, which comprise the same cross section over virtually their entire length. In this case, the cavity hence extends preferably over virtually their entire length.

An angle fastening element of this type can be fixed in a variety of ways relative to the bottom laths, in order to mutually fix the bottom laths. in this way, an angle fastening element of this type can be fitted clampingly into the said cavities, and/or with the aid of a click joint, and/or with the aid of additional fastening elements, such as, for example, screws, etc.

The cavities of the bottom laths preferably have dimensions adapted to the legs of the angle fastening element. These cavities can in this case have a greater cross section than the legs, but then preferably comprise ribs and/or partitions, etc. with which intermediate dimensions corresponding to the dimensions of the legs of the angle fastening element are provided.

Preferably, the bottom laths comprise in their cavity a mounting slot, for fitting of the corresponding leg guidingly into this cavity. In order to be able to fit the legs guidingly in these mounting slots so as to fit them into the corresponding cavity, these mounting slots will have a width corresponding to the respective leg. In this way, a leg of this type can be firmly fitted into the cavity of the respective bottom lath. The bottom laths hereby remain still better at the desired angle relative to each other after the angle fastening element has been fitted with its legs into the respective cavities of the bottom laths.

A mounting slot of this type can be shielded, for example, with the aid of internal ribs in the bottom laths. Internal ribs of this type can form part, for example, of screw channels of the bottom laths. As a result, these screw channels then have a dual function. They serve, on the one hand, for the fitting of screws herein and, on the other hand, for the securement of a leg of the angle fastening element in the cavity of the bottom lath.

Alternatively or additionally, the mounting slot can also be shielded, for example, with the aid of a partition.

The angle fastening element of a screen device according to this invention with angle fastening element is preferably substantially L-shaped.

Furthermore, the legs of an angle fastening element of this type are preferably constructed virtually identical to each other. As a result, the angle fastening element is reversible, wherein one leg is interchangeable with the other leg. It is immaterial whether the first leg is fitted into the cavity of the first bottom lath, or the second leg, and vice versa.

Preferably, the bottom laths, too, have a virtually same cross section.

The bottom laths of a screen device according to this invention are preferably mitred at the relevant end in order to mutually connect these at the said angle.

If these bottom laths, moreover, have virtually a same cross section, these can be connected to each other in mitred abutment, such that the bottom laths form a whole which runs throughout at an angle.

If these can then be mutually connected to an above-described angle fastening element, then these too, in case of deviations as a result of tolerances or environmental factors, can nevertheless be drawn virtually fully together, so that they can butt virtually fully against each other, without an opening therebetween.

With a substantially L-shaped angle fastening element and mitred bottom laths, it is possible, moreover, to hide the connection elements virtually fully from view. After the bottom laths have been fastened to each other, only screws are then possibly still visible. These screws can then be provided on a side of the bottom laths which in most positions is hidden from view. Typically this will be the underside of the bottom laths.

A screen device according to this invention is further preferably provided with drive means for the synchronous driving of both fabric rollers. With mutually connected bottom laths, the screens should namely always simultaneously be able to be rolled up and unrolled on the fabric rollers.

Specifically, the said drive means can for this comprise a bevel-geared transmission, for transmission of the drive of one of the two fabric rollers for driving of the other of the two fabric rollers.

This invention is now explained in greater detail on the basis of the hereinafter following detailed description of a preferential screen device according to this invention. The aim of this description is solely to provide illustrative examples and to indicate further advantages and particularities of this invention, and thus cannot be interpreted as a limitation of the field of application of the invention or of the patent rights claimed in the claims.

In this detailed description, reference is made by means of reference numerals to the hereto appended drawings, wherein in

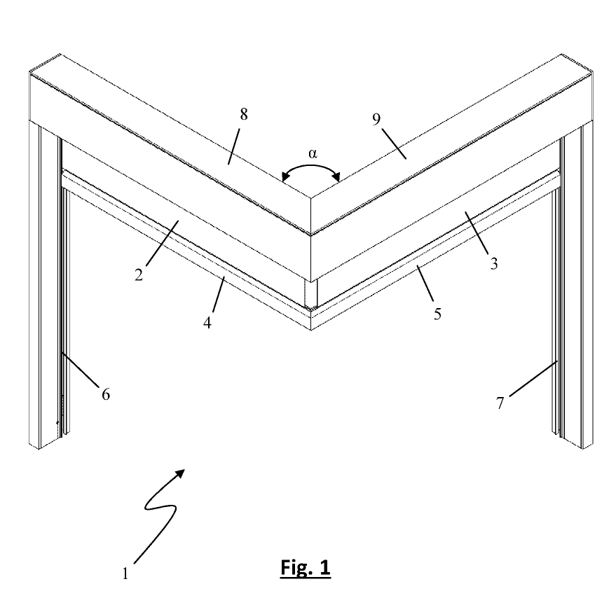

FIG. 1 a screen device according to this invention is represented in perspective view;

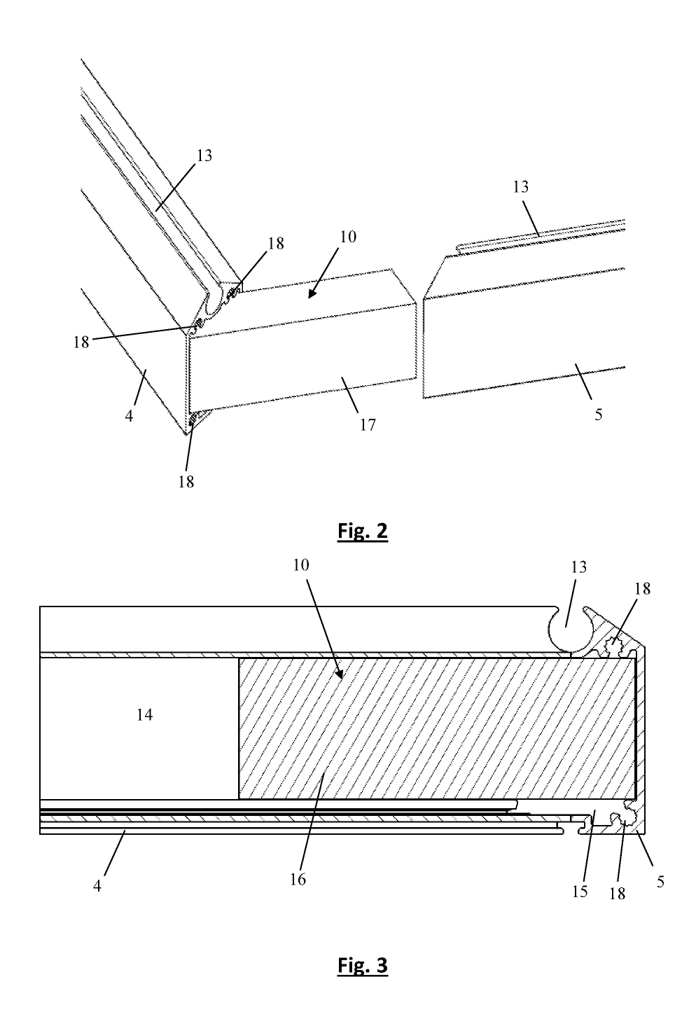

FIG. 2 the bottom laths of the screen device from FIG. 1 are represented singly in greater detail in perspective view at the level of their angle joint, with one of the bottom laths in the disassembled state;

FIG. 3 the bottom laths of the screen device from FIG. 1 are represented singly in greater detail in cross section at the level of their angle joint, sectioned through one of the bottom laths according to its longitudinal direction and transversely through the other bottom lath,

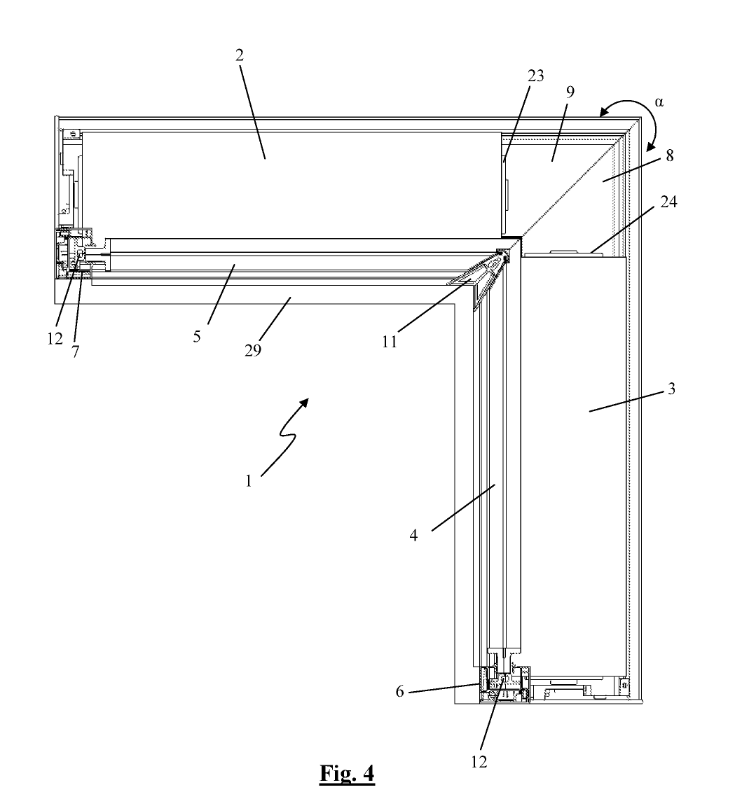

FIG. 4 a second embodiment of a screen device according to this invention is represented in bottom view, with cut-away screen boxes, so that a view is given of the content of these screen boxes;

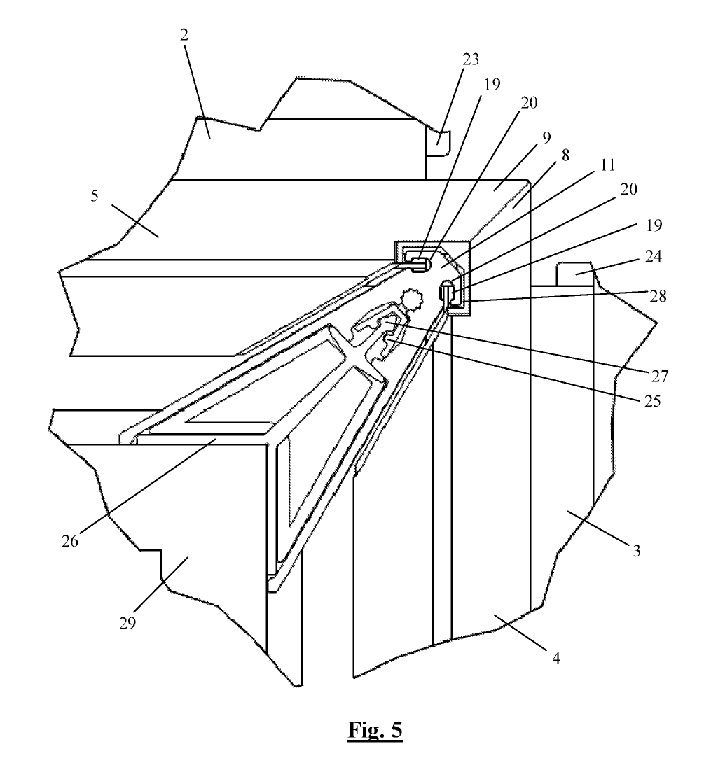

FIG. 5 a part of the screen device from FIG. 4 is represented in greater detail in bottom view at the level of the fixedly arranged screen guide thereof;

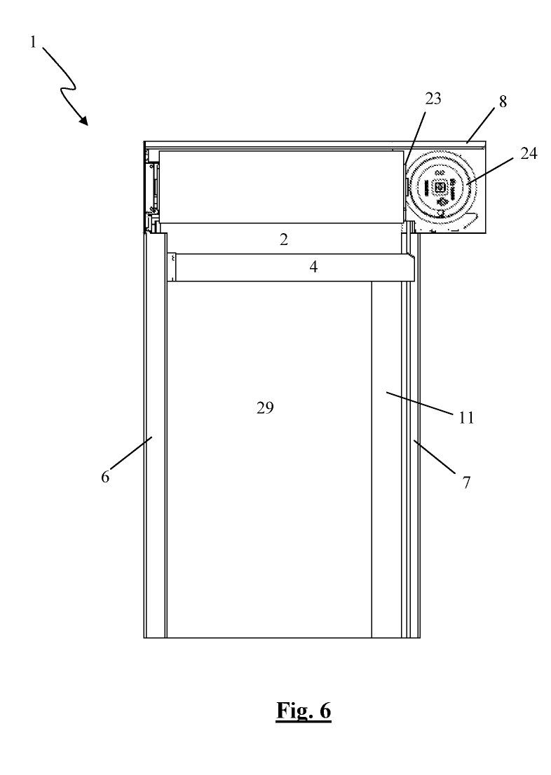

FIG. 6 the screen device from FIG. 4 is represented in elevation, with cut-away screen boxes, so that a view is given of the content of these screen boxes;

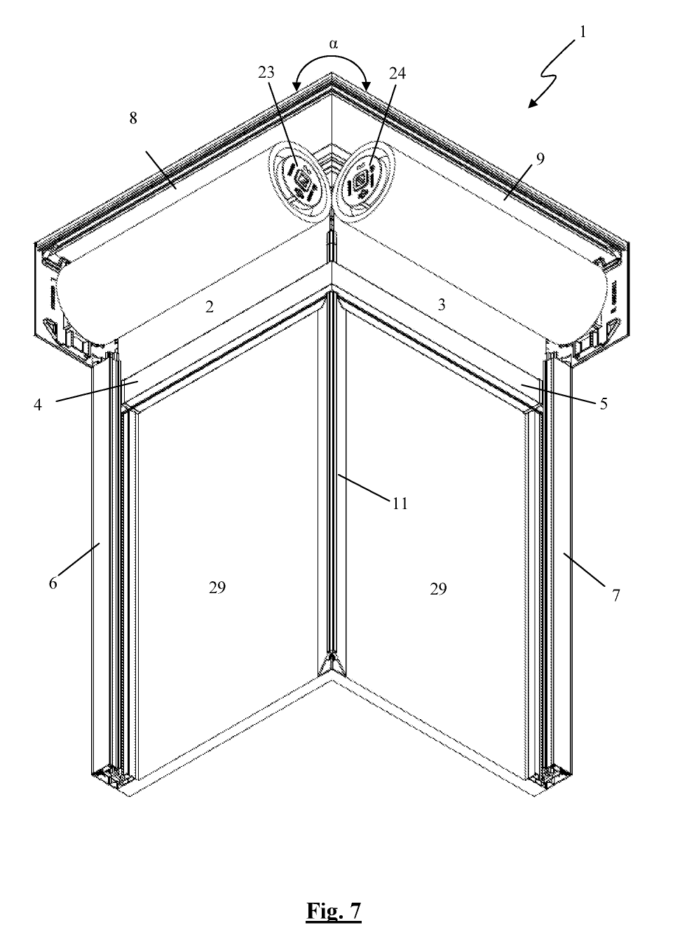

FIG. 7 the screen device from FIG. 4 is represented in perspective view from below, with cut-away screen boxes, so that a view is given of the content of these screen boxes.

The screen devices (1) depicted in the figures comprise two fabric rollers (23, 24), which are each accommodated in a respective screen box (8, 9) and only in the second depicted embodiment are visible in FIGS. 4-7. The fabric rollers (23, 24) are each rotatable about a respective fabric roller axis, wherein these fabric roller axes are arranged at an angle relative to each other. Given that these fabric roller axes extend according to the longitudinal direction of the screen boxes (8, 9), these screen boxes (8, 9) are hence also arranged at this said angle (α) relative to each other. To each of the fabric rollers (23, 24), a screen (2, 3) is fastened at one of its ends. Given that the fabric rollers (23, 24) are arranged rotatably about their fabric roller axis, the hereto fastened screens (2, 3) can be rolled up and unrolled on the respective fabric roller (23, 24).

To that end of the screens (2, 3) opposite to the end by which they are fastened to the respective fabric roller (23, 24) is respectively fastened a bottom lath (4, 5), so that the screens (2, 3) can sag under the weight of these bottom laths (4, 5). In this regard, the bottom laths (4, 5) comprise a mounting slot (13), as can be seen in FIGS. 2 and 3, in which a thickened margin of the respective screen (2, 3) can be fitted in order to fasten this screen (2, 3) to the bottom lath (4, 5).

On the lateral sides of the screens (2, 3) away from the angle (α), screen and lath guides (6, 7) are arranged. These screen and lath guides (6, 7) each comprise a fixedly arranged outer profile and a guide profile (12) fitted in this outer profile.

The screens (2, 3) are on this lateral side provided with a flexible thickening, which can be realized, for example, as a half zip fastener (19), as is depicted in the second embodiment. With this flexible thickening, the screens (2, 3) are hooked guidingly in place into a corresponding cavity (20) in the respective guide profile (12). These cavities (20) extend over the full length of these guide profiles (12).

The half zip fasteners (19) are preferably made of polyester or nylon in order to ensure a good guidance. There are also a number of alternatives for this type of half zip fastener (19) known as a flexible thickening (19), such as for example a cord which is fitted in the lateral side margin of the screen (2, 3), etc.

The guide profiles (12) are fitted with play in the outer profiles, wherein play is provided in a direction perpendicular to the longitudinal direction of these profiles. The guide profiles (12) are spring-cushioned with the aid of resilient material in the outer profile, so that the screens (2, 3) are spring-loaded. In this way, the screens (2, 3), in the event of possible overloading by, for example, a person knocking against the screen (2, 3), or under a wind load, can deflect somewhat, without damage to the screen (2, 3) or the screen device (1).

The respective ends of the bottom laths (4, 5) are on this lateral side away from the angle (a) fitted guidingly in the outer profile.

In the angle (α), the bottom laths (4, 5) are mutually connected.

The screen device (1) comprises in the first embodiment an angle fastening element (10) in order to be able to mutually connect the bottom laths (4, 5). To this end, the bottom laths (4, 5) are of hollow construction. If these are constructed substantially from a profile produced by extrusion, as is the case with the depicted bottom laths (4, 5), then this cavity (14, 15) will extend over the length of the relevant bottom lath (4, 5). The angle fastening element (10) is of virtually L-shaped construction and comprises two legs (16, 17), which are arranged at the relevant angle (α) relative to each other. Each of these legs (16, 17) is fittable into the cavity (14, 15) of a respective bottom lath (4, 5) via an access opening, as can be seen in FIGS. 2 and 3. In the cavity (14, 15) are respectively provided different screw channels (18), between which extend mounting slots which have dimensions corresponding to the leg (16, 17), so that the relevant leg (16, 17) of the angle fastening element (10) can be guidingly fitted herebetween. These screw channels (18) have in this case a dual function. On the one hand, they hold the leg (16, 17) in the desired place, whilst, on the other hand, screws can be fitted herein in order to be able, at the other end of the bottom lath (4, 5), to screw an end piece of the bottom lath (4, 5) onto this profile of the bottom lath (4, 5).

In place of or in addition to these screw channels (18), the cavity (14, 15) can alternatively itself also be accorded a shape corresponding to the respective leg (16, 17), or the cavity (14, 15) can be provided with internal vertical ribs or with a partition, etc. in order to be able to position the respective leg (16, 17) in this cavity (14, 15).

At the relevant end, the bottom laths (4, 5) are mitred (45° or more or less). The angle fastening element (10) can in this case be fitted fully into the bottom laths (4, 5), in which case the bottom laths (4, 5) butt one against the other and the angle fastening element (10) is hidden from view. Since the bottom laths (4, 5) have virtually the same cross section, a continuous whole is in this case formed at the angle (α).

In the second embodiment, the bottom laths (4, 5) can be mutually connected in an analogous manner.

In the first embodiment depicted in FIGS. 1-3, no screen and lath guides are arranged on the angle (α), so that, in the rolled-up state of the screens (2, 3), this angle below the screens (2, 3) and the hereto fastened bottom laths (4, 5) can be cleared, as can be seen in FIG. 1.

In the second embodiment, a guide profile (11) for guiding the lateral side of each screen (2, 3) is fixedly arranged on this angle (α) as the screen guide (11). This screen guide (11) is arranged between two screens (2, 3) and is provided with two cavities (20) for fitting of the flexible thickening (19) on the corresponding lateral side of these screens (2, 3) guidingly herein. This fixed screen guide (11) is here clicked in place on a fastening profile (26), wherein this screen guide (11) and this fastening profile (26) are provided with corresponding click means (25, 26) for the realization of this click joint. This screen guide (11) could however also be fastened to its environment without such click joint, by, for example, gluing, screwing, etc.

In the second screen device (1), in the bottom laths (4, 5), at the level of the fixedly arranged screen guide (11), there is made a recess (28), in which the fixedly arranged screen guide (11) can be guidingly fitted, so that both bottom laths (4, 5), during the roll-up and unrolling movement of the screens (2, 3), are also guided by this fixedly arranged screen guide (11).

Since the bottom laths (4, 5) in both depicted embodiments are mutually connected, the screens (2, 3) are preferably always rolled up and unrolled synchronously on the respective fabric rollers (23, 24). To this end, the screen device (1) can comprise drive means for the synchronous driving of these fabric rollers. Specifically, these drive means can for this comprise, for example, a bevel-geared transmission, for transmission of the drive of one of the two fabric rollers (23, 24) for driving of the other of the two fabric rollers (23, 24).

Such screen devices (1) can typically be arranged for a frame section (29), as depicted in FIGS. 4 to 7 for the second embodiment, in order to shield this frame section (29) at least partially from sunlight. If this frame section (29) can open, such screen devices (1) can typically also be used as a shield against insects. Such screen devices (1) can also be set up in free-standing arrangement or be accommodated in, for example, a terrace roof, in order to offer screening against sunlight or wind, etc. for an outside space.

1. Screen device comprising two fabric rollers, each, rotatable about a respective fabric roller axis, wherein the fabric roller axes of these fabric rollers in the mounted state of the screen device, are arranged at an angle relative to each other, and wherein the screen device, for each fabric roller:
comprises a screen, which can be rolled up and unrolled on the fabric roller;
comprises a bottom lath, which in the mounted state of the screen device, is fastened to the screen on a side of the screen distal from the fabric roller;
and comprises one or more screen and/or lath guides, for guiding a lateral side of the screen and/or the bottom lath; characterized in that, in the mounted state of the screen device, the bottom laths are mutually connected at the said angle.

2. Screen device according to claim 1, characterized in that the guides are arranged only on the lateral side of the respective screen and/or the respective bottom lath, away from the said angle.

3. Screen device according to claim 1, characterized in that, for the guidance of the corresponding lateral side of each screen, a guide profile is fixedly arranged on the angle as a screen guide, and in that, on the lateral side of each respective screen and/or each respective bottom lath, away from the said angle, a guide profile for guiding this corresponding lateral side of the screen, is resiliently mounted in an outer profile of the screen guide, for the laterally resilient tensioning of the screen.

4. Screen device according to claim 3, characterized in that the guide profiles for guiding the lateral sides of the screens on the angle form part of a same screen guide.

5. Screen device according to claim 3, characterized in that the bottom laths comprise on the angle a recess, for fitting of the corresponding guide profile guidingly herein.

6. Screen device according to claim 3, characterized in that the guide profiles, on the angle, comprise click means for clicking these guide profiles in place on a fastening profile of the screen device.

7. Screen device according to claim 1, characterized in that the lateral sides of the screens and/or of the bottom laths, which are intended to be guided, are provided with one or more hook elements to hook into the screen and/or lath guides for guidance of these lateral sides in these screen and/or lath guides.

8. Screen device according to claim 7, characterized in that the screens, on their lateral side which is intended to be guided, are provided with a flexible thickening as the said hook element.

9. Screen device according to claim 8, characterized in that, in the mounted state of the screen device, the ends of the screens are clamped in the respective bottom laths, such that the flexible thickenings at these ends extend laterally relative to the respective bottom laths in order to form the said hook elements for the bottom laths.

10. Screen device according to claim 1, characterized in that the bottom laths are of hollow construction, and comprise an access opening to their cavity on the side of the said angle, and in that the screen device comprises an angle fastening element, comprising two legs which are arranged at the said angle relative to each other and are each fittable into the cavity of a respective bottom lath via the respective access opening, for the mutual connection of these bottom laths at the said angle.

11. Screen device according to claim 10, characterized in that the bottom laths comprise in their cavity a mounting slot, for fitting of the corresponding leg guidingly into this cavity.

12. Screen device according to claim 11, characterized in that the bottom laths comprise screw channels, which delimit their mounting slot.

13. Screen device according to claim 1, characterized in that the bottom laths are mitred at the relevant end in order to mutually connect these at the said angle.

14. Screen device according to claim 1, characterized in that this screen device is provided with drive means for the synchronous driving of both fabric rollers.

15. Screen device according to claim 14, characterized in that the said drive means comprises a bevel-geared transmission, for transmission of the drive of one of the two fabric rollers for driving of the other of the two fabric rollers.
